(19) United States
(12) Patent Application Publication
(10) Pub. No.: US 2026/0252520 A1
(43) Pub. Date: Aug. 27, 2026

(54) PCIE RETIMER, PCIE SYSTEM AND ELECTRONIC DEVICE

(71) Applicant: SILICON INNOVATION MICROELECTRONICS CO., LTD., Chengdu (CN)

(72) Inventors: Jun FENG, Chengdu (CN); Silin QIN, Chengdu (CN); Kang FU, Chengdu (CN); Junjie JIAN, Chengdu (CN); Yunwu PENG, Chengdu (CN)

(73) Assignee: SILICON INNOVATION MICROELECTRONICS CO., LTD., Chengdu (CN)

(21) Appl. No.: 19/358,473

(22) Filed: Oct. 15, 2025

(30) Foreign Application Priority Data
Feb. 26, 2025 (CN) 202510214446.2

(51) Int. Cl. G06F 13/42

(52) U.S. Cl. CPC G06F 13/423; G06F 2213/0026

(57) ABSTRACT

A PCIe retimer, a PCIe system, and an electronic device are provided. In the PCIe retimer, a decoding-descrambling unit receives data inputted via an ingress lane connected to the decoding-descrambling unit, performs decoding-descrambling processing, and outputs a decoded and descrambled data stream; a processing unit determines, based on the data stream outputted by each decoding-descrambling unit, a channel delay skew compensation for a channel, and transmits the channel delay skew compensation to a deskewing unit; the deskewing unit performs deskew processing on the decoded and descrambled data stream based on the channel delay skew compensation, and outputs the deskewed data stream; and an encoding-scrambling unit performs encoding-scrambling processing on the received deskewed data stream, and outputs an encoded and scrambled data stream.

This application claims priority to Chinese Patent Application No. 202510214446.2, titled “PCIE RETIMER, PCIE SYSTEM AND ELECTRONIC DEVICE”, filed on Feb. 26, 2025 with the China National Intellectual Property Administration, which is incorporated herein by reference in its entirety.

### FIELD

The present disclosure relates to the technical field of chips, and in particular to a PCIe retimer, a PCIe system and an electronic device.

### BACKGROUND

In a peripheral component interconnect express (PCIe) system where a root complex (RC) and an endpoint (EP) device are interconnected, when a PCIe transmission rate exceeds a certain threshold, PCIe signals experience significant attenuation when traveling through printed circuit board (PCB) traces. To address the signal attenuation issue, a PCIe retimer is required between the root complex and the endpoint device.

The PCIe retimer arranged in the PCIe system receives data from the root complex, performs lane decoding and descrambling, deskew processing, and lane encoding and scrambling on the data in sequence, and then transmits the data to the endpoint device via a PCIe physical layer (PCIe PHY).

In a traditional PCIe system, when the PCIe retimer performs the deskewing processing, system delay is greatly increased, and system interaction efficiency is affected.

### SUMMARY

The objective of the present disclosure is to provide a peripheral component interconnect express (PCIe) retimer, a PCIe system, an electronic device, and a method for signal processing, to address the above issue.

To achieve the above objective, the following technical solutions are provided in the present disclosure.

In a first aspect, a PCIe retimer is provided in an embodiment of the present disclosure. The PCIe retimer includes a deskewing unit, a processing unit, N decoding-descrambling units and N encoding-scrambling units.

An input terminal of an i-th decoding-descrambling unit of the N decoding-descrambling units is connected to an i-th ingress lane, an output terminal of the i-th decoding-descrambling unit is connected to an i-th input terminal of the processing unit and an i-th input terminal of the deskewing unit, an i-th output terminal of the deskewing unit is connected to an input terminal of an i-th encoding-scrambling unit of the N encoding-scrambling units, and an output terminal of the i-th encoding-scrambling unit is connected to an i-th egress lane, where 1≤i≤N. The processing unit is connected to the deskewing unit.

A decoding-descrambling unit of the N decoding-descrambling unit is configured to receive data inputted via an ingress lane connected to the decoding-descrambling unit, to perform decoding-descrambling processing, and to output a decoded and descrambled data stream.

The processing unit is configured to determine, based on the data stream outputted by each decoding-descrambling unit of the N decoding-descrambling units, a channel delay skew compensation for a channel, and to transmit the channel delay skew compensation to the deskewing unit. The channel includes one ingress lane and one egress lane.

The deskewing unit is configured to perform deskew processing on the decoded and descrambled data stream based on the channel delay skew compensation, and to output a deskewed data stream.

An encoding-scrambling unit of the N encoding-scrambling unit is configured to perform encoding-scrambling processing on the received deskewed data stream, and to output an encoded and scrambled data stream.

In the embodiments of the present disclosure, a delay skew of an entire channel is considered during the deskew processing, which reduces an amount of a delay skew compensation, thereby significantly reducing data transmission delay and improving the data transmission efficiency.

In an embodiment, the PCIe retimer further includes a first lane mapping unit.

The i-th output terminal of the deskewing unit is connected to an i-th input terminal of the first lane mapping unit, an i-th output terminal of the first lane mapping unit is connected to the input terminal of the i-th encoding-scrambling unit, and the processing unit is connected to the first lane mapping unit.

The processing unit is configured to generate, based on the data stream outputted by each decoding-descrambling unit of the N decoding-descrambling units, a mapping relationship set, and to transmit the mapping relationship set to the first lane mapping unit. The mapping relationship set includes N mapping relationships. A j-th mapping relationship corresponds to a j-th channel. The j-th mapping relationship is a mapping relationship between the j-th ingress lane and an (N+1−j)-th egress lane that are sorted based on delay skew, where 1≤j≤N.

The first lane mapping unit is configured to perform, based on the mapping relationship set, switching on input terminals and output terminals of the first lane mapping unit, to connect the input terminal corresponding to the j-th ingress lane and the output terminal corresponding to the (N+1−j)-th egress lane, and is configured to forward a received deskewed data stream.

It should be understood that channel delay skews of the N channels constructed according to the above technical solutions are even, which may reduce the channel delay skew compensation, and thereby reducing the communication delay and improving the interaction efficiency.

In an embodiment, the processing unit includes an ingress recording unit, an ingress sorting unit, an egress recording unit, an egress sorting unit, and a mapping construction unit.

The ingress recording unit is connected to the ingress sorting unit. The egress recording unit is connected to the egress sorting unit. Both the ingress sorting unit and the egress sorting unit are connected to the mapping construction unit. The output terminal of the i-th decoding-descrambling unit is connected to an i-th access terminal of the ingress recording unit. The mapping construction unit is connected to the first lane mapping unit.

The ingress recording unit is configured to determine, based on the data stream outputted by each decoding-descrambling unit of the N decoding-descrambling units, the delay skew of each ingress lane of N ingress lanes, and to transmit the delay skew of each ingress lane of the N ingress lanes to the ingress sorting unit.

The egress recording unit is configured to transmit the delay skew of each egress lane of the N egress lanes to the egress sorting unit.

The ingress sorting unit is configured to sort the delay skew of each ingress lane of the N ingress lanes.

The egress sorting unit is configured to sort the delay skew of each egress lane of the N egress lanes.

When an ascending order is adopted by the ingress sorting unit, a descending order is adopted by the egress sorting unit, and when a descending order is adopted by the ingress sorting unit, an ascending order is adopted by the egress sorting unit.

The mapping construction unit is configured to construct a j-th mapping relationship based on a j-th ingress lane sorted by the ingress sorting unit and a j-th egress lane sorted by the egress sorting unit, to generate the mapping relationship set, and to transmit the mapping relationship set to the first lane mapping unit.

By sorting through the ingress sorting unit and the egress sorting unit, the mapping relationship may be quickly and accurately determined, thereby improving the efficiency of channel construction and ensuring a communication speed.

In an embodiment, the ingress recording unit is configured to determine a target arrival time corresponding to the i-th decoding-descrambling unit, where the target arrival time is arrival time of target information in a data stream outputted by a decoding-descrambling unit.

The ingress recording unit is configured to determine, based on target arrival time corresponding to each decoding-descrambling unit of the N decoding-descrambling units, delay skew of each ingress lane of the N ingress lanes.

In an embodiment, the processing unit further includes a residual value compensation unit. The residual value compensation unit is connected to the mapping construction unit and the deskewing unit respectively.

The residual value compensation unit is configured to determine a minimum value among total delays of N channels as a first reference value. A total delay of a j-th channel is a sum of a delay skew of an ingress lane included in the j-th channel and a delay skew of an egress lane included in the j-th channel.

The residual value compensation unit is configured to determine a difference between the total delay of the j-th channel and the first reference value as a channel delay skew of the j-th channel.

The residual value compensation unit is configured to determine a maximum value among channel delay skews of the N channels as a second reference value.

The residual value compensation unit is configured to determine a difference between the second reference value and the channel delay skew of the j-th channel as a channel delay skew compensation for the j-th channel, and to transmit j-th channel information to the deskewing unit. The j-th channel information includes the channel delay skew compensation for the j-th channel and an ingress lane identifier of the j-th channel.

The delay of data received by a second device is minimized as much as possible, which is ideally reduced to 0, to save deskew buffer space required by the second device.

In an embodiment, the delay skew of the egress lane is obtained through in-band data stream transmission, out-band reading, or configuration after upper-layer software reading.

In a second aspect, a PCIe system is provided in an embodiment of the present disclosure. The PCIe system includes a first device, a second device, and the PCIe retimer described above.

An i-th output terminal of the first device is connected to the input terminal of the i-th decoding-descrambling unit via the i-th ingress lane, and an i-th input terminal of the second device is connected to the output terminal of the i-th encoding-scrambling unit via the i-th egress lane.

When the first device is configured as a root complex device, the second device is configured as an endpoint device. When the first device is configured as an endpoint device, the second device is configured as a root complex device.

In an embodiment, the second device includes a second lane mapping unit when the PCIe retimer includes the first lane mapping unit.

An i-th input terminal of the second lane mapping unit is connected to the i-th egress lane.

The second lane mapping unit is configured to perform, based on the mapping relationship set, reverse switching on input terminals and output terminals of the second lane mapping unit. The reverse switching indicates that a switching relationship in the second lane mapping unit and a switching relationship in the first lane mapping unit are reversed.

In a third aspect, an electronic device is provided in an embodiment of the present disclosure.

In a fourth aspect, a method for signal processing is provided in an embodiment of the present disclosure. The method is applied to a PCIe retimer, and includes:
receiving data inputted via an ingress lane, performing decoding-descrambling processing, and outputting a decoded and descrambled data stream;
determining, based on the decoded and descrambled data stream, a channel delay skew compensation for a channel, and outputting the channel delay skew compensation, where the channel includes one ingress lane and one egress lane;
performing deskew processing on the decoded and descrambled data stream based on the channel delay skew compensation, and outputting a deskewed data stream; and
performing encoding-scrambling processing on the deskewed data stream, and outputting an encoded and scrambled data stream.

In an embodiment, the method further includes:
generating, based on the decoded and descrambled data stream, a mapping relationship set, where the mapping relationship set includes N mapping relationships, a j-th mapping relationship corresponds to a j-th channel, and the j-th mapping relationship is a mapping relationship between the j-th ingress lane and an (N+1−j)-th egress lane that are sorted based on delay skew, where 1≤j≤N; and
connecting, based on the mapping relationship set, an input terminal corresponding to the j-th ingress lane and an output terminal corresponding to the (N+1−j)-th egress lane, and outputting the deskewed data stream.

In an embodiment, the method further includes:
determining, based on the decoded and descrambled data stream, delay skew of each ingress lane of N ingress lanes; and
generating the mapping relationship set based on the delay skews of the N ingress lanes and delay skews of N egress lanes.

In an embodiment, the method further includes:
sorting the delay skew of each ingress lane of the N ingress lanes, and sorting the delay skew of each egress lane of the N egress lanes, where when each ingress lane of the N ingress lanes is sorted in an ascending order, each egress lane of the N egress lanes is sorted in a descending order, and when each ingress lane of the N ingress lanes is sorted in a descending order, each egress lane of the N egress lanes is sorted in an ascending order; and
constructing a j-th mapping relationship based on a j-th ingress lane and a j-th egress lane, and generating the mapping relationship set.

In an embodiment, the method further includes:
determining arrival time of target information in the decoded and descrambled data stream; and
determining, based on the arrival time, delay skew of each ingress lane of the N ingress lanes.

In an embodiment, the method further includes:
determining a minimum value among total delays of N channels as a first reference value, where a total delay of a j-th channel is a sum of a delay skew of an ingress lane included in the j-th channel and a delay skew of an egress lane included in the j-th channel;
determining a difference between the total delay of the j-th channel and the first reference value as a channel delay skew of the j-th channel;
determining a maximum value among channel delay skews of the N channels as a second reference value; and
determining a difference between the second reference value and the channel delay skew of the j-th channel as a channel delay skew compensation for the j-th channel, where the j-th channel information includes the channel delay skew compensation for the j-th channel and an ingress lane identifier of the j-th channel.

In an embodiment, the delay skew of the egress lane is obtained through in-band data stream transmission, out-band reading, or configuration after upper-layer software reading.

In order to make the above objective, features and advantages of the present disclosure more comprehensible, preferred embodiments are described in detail in conjunction with drawings below.

### BRIEF DESCRIPTION OF THE DRAWINGS

In order to more clearly illustrate the technical solutions in the embodiments of the present disclosure, drawings in the embodiments of the present disclosure are briefly described below. It should be understood that, the following drawings are only show some embodiments of the present disclosure, and other drawings may be obtained by those skilled in the art from the drawings without any creative work.

FIG. 1 is a schematic structural diagram of a peripheral component interconnect express (PCIe) retimer according to an embodiment of the present disclosure.

FIG. 2 is a schematic diagram of channels according to an embodiment of the present disclosure.

FIG. 3 is a schematic structural diagram of a PCIe retimer according to another embodiment of the present disclosure.

FIG. 4 is a schematic structural diagram of a processing unit according to an embodiment of the present disclosure.

FIG. 5 is a schematic flowchart of a method for signal processing according to an embodiment of the present disclosure.

Reference numerals in the drawings are as follows.

| | |
|---|---|
| 10: Deskewing unit | 20: Processing unit |
| 21: Ingress recording unit | 22: Ingress sorting unit |
| 23: Egress recording unit | 24: Egress sorting unit |
| 25: Mapping construction unit | 26: Residual value compensation unit |
| 30: Decoding-descrambling unit | 40: Encoding-scrambling unit |
| 50: First lane mapping unit | 60: First PCIe interface |
| 70: Second PCIe interface | |

### DETAILED DESCRIPTION

In order to make the objective, technical solutions and advantages of the embodiments of the present disclosure clearer, the technical solutions in the embodiments of the present disclosure are to be clearly and completely described below in conjunction with the drawings in the embodiments of the present disclosure. Apparently, the embodiments described below are only some embodiments of the present disclosure, rather than all the embodiments. In general, the components of the embodiments of the present disclosure described and illustrated in the drawings herein may be arranged and designed in various different configurations.

Accordingly, the following detailed description of the embodiments of the present disclosure provided in the drawings is not intended to limit the scope of the claims of the present disclosure, but merely represents selected embodiments of the present disclosure. All other embodiments obtained by those skilled in the art based on the embodiments of the present disclosure without any creative work fall within the protection scope of the present disclosure.

It should be noted that similar numerals and signs in the following figures represent similar objects. Hence, an item defined for a figure may not be further defined and explained for subsequent figures. In addition, in the description of the present disclosure, terms such as “first” and “second” are only for illustrative purposes, and should not be construed as indicating or implying relative importance.

It should be noted that in the present disclosure, relationship terminologies such as “first” and “second” are only used to distinguish one entity or operation from another entity or operation, rather than to necessitate or imply an actual relationship or order between the entities or operations. Moreover, terms “include”, “comprise” or any variants thereof are intended to be non-exclusive. Therefore, a procedure, method, article or device including a series of elements includes not only the elements but also other elements that are not enumerated, or further includes elements inherent to the process, method, article or device.

Hereinafter some embodiments of the present disclosure are described in detail in conjunction with the drawings. Embodiments and features described hereinafter may be combined with each other as long as there is no conflict.

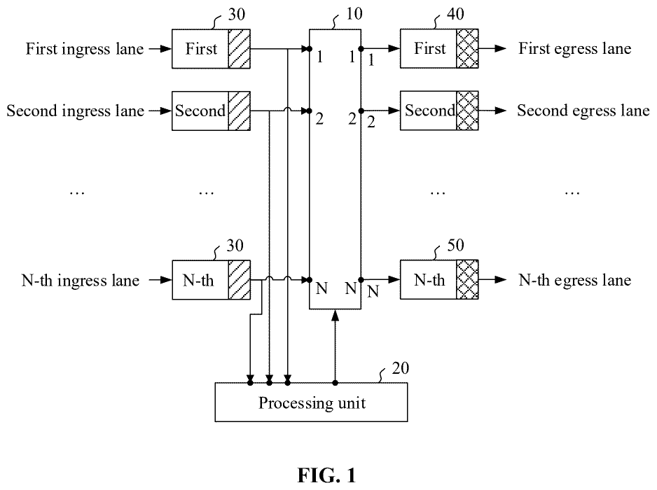

A peripheral component interconnect express (PCIe) retimer is provided according to an embodiment of the present disclosure. The PCIe retimer adaptively performs deskew processing to optimize the deskew processing, thereby reducing the system delay. Reference is made to FIG. 1, which is a schematic structural diagram of a PCIe retimer according to an embodiment of the present disclosure.

The PCIe retimer includes a deskewing unit 10, a processing unit 20, N decoding-descrambling units 30 and N encoding-scrambling units 40.

An input terminal of an i-th decoding-descrambling unit 30 of the N decoding-descrambling units 30 is connected to one end of an i-th ingress lane, and the other end of the i-th ingress lane is connected to an i-th output terminal of a first device (not shown in FIG. 1). An output terminal of the i-th decoding-descrambling unit 30 is connected to an i-th input terminal of the processing unit 20 and an i-th input terminal of the deskewing unit 10. An i-th output terminal of the deskewing unit 10 is connected to an input terminal of an i-th encoding-scrambling unit 40 of the N encoding-scrambling units 40. An output terminal of the i-th encoding-scrambling unit 40 is connected to one end of an i-th egress lane. The other end of the i-th egress lane is connected to a second device (not shown in FIG. 1). N is in a range as follows: 1≤i≤N. The processing unit 20 is connected to the deskewing unit 10.

When the first device is configured as a root complex (RC) device, the second device is configured as an endpoint (EP) device. When the first device is configured as an endpoint device, the second device is configured as a root complex device.

A decoding-descrambling unit 30 of the N decoding-descrambling units 30 is configured to receive data inputted via an ingress lane connected to the decoding-descrambling unit, to perform decoding-descrambling processing, and to output a decoded and descrambled data stream.

It should be noted that the i-th decoding-descrambling unit 30 receives data inputted via the i-th ingress lane and performs decoding-descrambling processing on the inputted data to obtain a decoded and descrambled data stream corresponding to the i-th ingress lane. The deskewing unit 10 and the processing unit 20 are provided at an output terminal of a decoding-descrambling unit 30 of the N decoding-descrambling units 30.

The processing unit 20 is configured to determine, based on the decoded and descrambled data stream outputted by each decoding-descrambling unit 30 of the N decoding-descrambling units 30, a channel delay skew compensation for a channel, and to transmit the channel delay skew compensation to the deskewing unit 10. The channel includes one ingress lane and one egress lane.

The channel delay skew compensation is determined based on a delay skew of an ingress lane included in the channel and a delay skew of an egress lane included in the channel. The processing unit 20 may determine a delay skew of an ingress lane included in a channel based on a data stream outputted by each decoding-descrambling unit 30 of the N decoding-descrambling units 30, and determine a channel delay skew compensation for the channel in conjunction with a delay skew of an egress lane included in the channel.

It should be noted that the PCIe retimer is provided with N channels. An ingress lane and an egress lane included in a channel are different from an ingress lane and an egress lane included in another channel among the N channels. A j-th channel may include a j-th ingress lane and a j-th egress lane that are sorted based on position, where j denotes a position sequence number of a lane. The j-th channel may also include a j-th ingress lane and an (N+1−j)-th egress lane that are sorted based on delay skew, where j denotes a delay skew sequence number of a lane.

Sorting based on position may be, but is not limited to, sorting from top to bottom or left to right. Sorting based on delay skew may be sorting based on delay skew in an ascending order or a descending order.

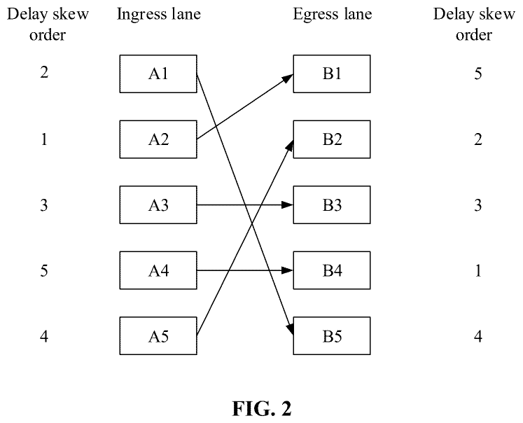

Reference is made to FIG. 2, which is a schematic diagram of channels according to an embodiment of the present disclosure. As shown in FIG. 2, it is assumed that 5 ingress lanes and 5 egress lanes are configured. The ingress lanes may be sorted based on position as A1-A2-A3-A4-A5, and the egress lanes may be sorted based on position as B1-B2-B3-B4-B5. When the j-th ingress lane and the j-th egress lane, which are sorted based on position, are included in the j-th channel, the ingress lane A1 and the egress lane B1 constitute a first channel, and the ingress lane A2 and the egress lane B2 constitute a second channel. Similarly, the ingress lane A5 and the egress lane B5 constitute a fifth channel.

As shown in FIG. 2, the ingress lanes may be sorted based on delay skew as a sequence of A2-A1-A3-A5-A4, and the egress lanes may be sorted based on delay skew as a sequence of B4-B2-B3-B5-B1. It should be noted that sorting rules of the ingress lanes and sorting rules of the egress lanes are the same in FIG. 2, and may be in a descending order or in an ascending order. When sorted in ascending order, delay skews in the sequence of A2-A1-A3-A5-A4 increase in sequence, and delay skews in the sequence of B4-B2-B3-B5-B1 increase in sequence. When the j-th ingress lane and the (N+1−j)-th egress lane, which are sorted based on delay skew (in a descending order or in an ascending order) are included in the j-th channel, the ingress lane A2 and the egress lane B1 constitute a first channel, the ingress lane A1 and the egress lane B5 constitute a second channel. Similarly, the ingress lane A4 and egress lane B4 constitute a fifth path.

The deskewing unit 10 is configured to perform deskew processing on the decoded and descrambled data stream based on the channel delay skew compensation, and to output a deskewed data stream.

A decoded and descrambled data stream on the j-th channel is a decoded and descrambled data stream outputted by the decoding-descrambling unit connected to an ingress lane included in the j-th channel.

It should be noted that, in a case that the j-th ingress lane and the j-th egress lane, which are sorted based on position, are included in the j-th channel, the j-th channel corresponds to the j-th ingress lane, the j-th ingress lane corresponds to a j-th decoding-descrambling unit, and the decoded and descrambled data stream on the j-th channel is a decoded and descrambled data stream outputted by the j-th decoding-descrambling unit.

In a case that the j-th ingress lane and the (N+1−j)-th egress lane, which are sorted based delay skew, are included in the j-th channel, the j-th channel corresponds to the j-th ingress lane sorted based on delay skew.

An encoding-scrambling unit 40 of the N encoding-scrambling units 40 or a first lane mapping unit 50 described below is provided at an output terminal of the deskewing unit 10.

The encoding-scrambling unit 40 is configured to perform encoding-scrambling processing on the received deskewed data stream, and to output an encoded and scrambled data stream.

In the embodiments of the present disclosure, a delay skew of an entire channel is considered during the deskew processing, which reduces an amount of a delay skew compensation, thereby significantly reducing data transmission delay and improving the data transmission efficiency.

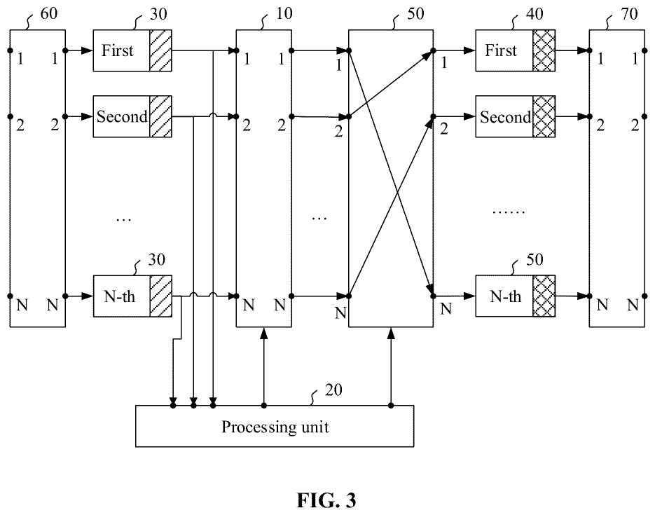

On the basis of the foregoing, an embodiment is provided in the present disclosure to further reduce the delay and improve the communication efficiency. Reference is made to FIG. 3, which is a schematic structural diagram of a PCIe retimer according to another embodiment of the present disclosure.

The PCIe retimer further includes a first lane mapping unit 50.

The i-th output terminal of the deskewing unit 10 is connected to an i-th input terminal of the first lane mapping unit 50, an i-th output terminal of the first lane mapping unit 50 is connected to the input terminal of the i-th encoding scrambling unit 40, and the processing unit 20 is connected to the first lane mapping unit 50.

The processing unit 20 is configured to generate a mapping relationship set based on the data stream outputted by each decoding-descrambling unit 30 of the N decoding-descrambling units 30, and to transmit the mapping relationship set to the first lane mapping unit 50. The mapping relationship set includes N mapping relationships. A j-th mapping corresponds to the j-th channel. The j-th mapping relationship is a mapping relationship between the j-th ingress lane and the (N+1−j)-th egress lane sorted based on delay skew, where 1≤j≤N.

It should be understood that channel delay skews of the N channels constructed according to the above technical solutions are even, which may reduce the channel delay skew compensation, and thereby reducing the communication delay and improving the interaction efficiency.

The first lane mapping unit 50 is configured to perform, based on the mapping relationship set, switching on input terminals and output terminals of the first lane mapping unit 50, to connect the input terminal corresponding to the j-th ingress lane and the output terminal corresponding to the (N+1−j)-th egress lane, and is configured to forward a received deskewed data stream, where j denotes the delay skew sequence number of a lane.

It should be understood that a transmission path of a data stream may change after the first lane mapping unit 50 performs internal connection relationship switching. Referring to FIG. 2, a data stream transmitted via the ingress lane A2 is outputted via the egress lane B1. To ensure that the second device may receive an ordered data stream outputted by the first lane mapping unit 50, the processing unit 20 may transmit the mapping relationship set to the second device through the data stream before the first lane mapping unit 50 performs the switching, so that the second device performs channel calibration based on the mapping relationship set to ensure that the data stream is transmitted in a predetermined order.

On the basis of the foregoing, how to generate the mapping relationship set is described in an embodiment of the present disclosure as an optional implementation.

The processing unit 20 is configured to determine delay skew of each ingress lane of the N ingress lanes based on data stream outputted by each decoding-descrambling unit 50 of the N decoding-descrambling units 30.

The processing unit 20 is configured to generate the mapping relationship set based on delay skews of the N ingress lanes and delay skews of N egress lanes.

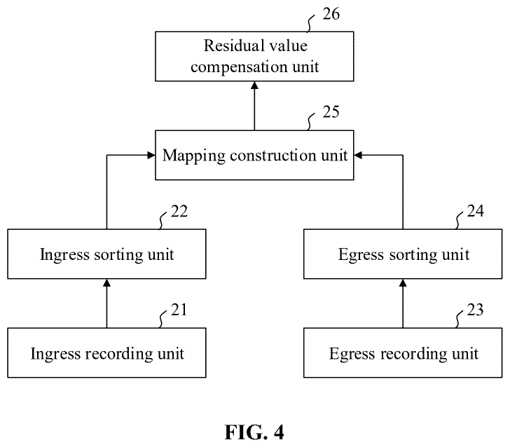

Reference is made to FIG. 4, which is a schematic structural diagram of a processing unit according to an embodiment of the present disclosure. The processing unit 20 includes an ingress recording unit 21, an ingress sorting unit 22, an egress recording unit 23, an egress sorting unit 24, and a map construction unit 25.

The ingress recording unit 21 is connected to the ingress sorting unit 22. The egress recording unit 23 is connected to the egress sorting unit 24. Both the ingress sorting unit 22 and the ingress sorting unit 24 are connected to the mapping construction unit 25. The output terminal of the i-th decoding-descrambling unit 30 is connected to an i-th access terminal of the ingress recording unit 21. The mapping construction unit 25 is connected to the first lane mapping unit 50.

The ingress recording unit 21 is configured to determine the delay skews of ingress lane of the N ingress lanes based on data stream outputted by each decoding-descrambling unit 30 of the N decoding-descrambling units 30, and to transmit the delay skew of each ingress lane of the N ingress lanes to the ingress sorting unit 22.

Delays are different among lanes connected to the PCIe retimer and vary at different PCIe rates. Thus, the ingress recording unit 21 is arranged in the PCIe retimer to record delay skews of ingress lanes.

In an embodiment, the ingress recording unit 21 is configured to determine target arrival time corresponding to the i-th decoding-descrambling unit 30. The target arrival time is arrival time of target information in a data stream outputted by a decoding-descrambling unit. The ingress recording unit 21 is configured to determine delay skew of each ingress lane of the N ingress lanes based on target arrival times corresponding to each decoding-descrambling unit 30 of the N decoding-descrambling units 30.

In an embodiment, a delay skew of an ingress lane corresponding to an earliest target arrival time is determined to be 0, and delay skews of other ingress lanes are respective differences between the target arrival time of the ingress lanes and the earliest target arrival time. Delay skews of ingress lanes are recorded as shown in Table 1.

TABLE 1

| Ingress Lane | Delay Skew |
|---|---|
| Sequence Number | (Skew Value) |
| Lane_in[a] | Delta Ta |
| Lane_in [b] | Delta Tb |
| Lane_in[c] | Delta Tc |
| Lane_in[d] | Delta Td |
| Lane_in[w] | Delta Tw |
| . . . | . . . |
| Lane_in[z] | Delta Tz |

The egress recording unit 23 is configured to transmit the delay skew of each egress lane of the N egress lanes to the egress sorting unit 24.

It should be noted that delay skews of the egress lanes are recorded following a same principle of the delay skews of the ingress lanes, and are not repeated herein.

The egress recording unit 23 may receive delay data of egress lanes transmitted by the second device. The delay data of the egress lanes includes delay skew of each egress lane of the N the egress lanes. Alternatively, the egress recording unit 23 may be configured by a user through a static system setting to obtain the delay skew of each egress lane of the N the egress lanes. The delay skew of the egress lane may be obtained through in-band data stream transmission, out-band reading, or configuration after upper-layer software reading.

The ingress sorting unit 22 is configured to sort the delay skew of each ingress lane of the N the ingress lanes.

The egress sorting unit 24 is configured to sort the delay skew of each egress lane of the N the egress lanes.

When an ascending order is adopted by the ingress sorting unit 22, a descending order is adopted by the egress sorting unit 24. When a descending order is adopted by the ingress sorting unit 22, an ascending order is adopted by the egress sorting unit 24.

In an embodiment, an array of delay skews sorted in a descending order by the ingress sorting unit 22 is obtained as follows: {Lane_in[a], Lane_in[b], . . . , Lane_in[w]}. A delay skew having the smallest Delta T is Lane_in[w], and a delay skew having the largest Delta T is Lane_in[a]. Delta T represents a delay skew of a lane, and Lane_in represents an ingress lane.

An array of delay skews sorted in an ascending order by the egress sorting unit 24 is obtained as follows: {Lane_out[p], Lane_out[q], . . . , Lane_out[z]}. A delay skew having the smallest Delta T is Lane_out[p], and a delay skew having the largest Delta T is Lane_out[z]. Lane_out represents an outlet lane.

The mapping construction unit 25 is configured to construct a j-th mapping relationship based on a j-th ingress lane sorted by the ingress sorting unit 22 and a j-th egress lane sorted by the egress sorting unit 24 to generate a mapping relationship set, and to transmit the mapping relationship set to the first lane mapping unit 50.

Referring to the above embodiment, Lane_in[a] and Lane_out[p] constitute one channel, Lane_in[b] and Lane out[q] constitute one channel. Similarly, Lane_in[w] and Lane_out[z] constitute one channel.

It should be noted that the j-th egress lane sorted in a descending order by the egress sorting unit 24 is an (N+1−j)-th egress lane sorted in an ascending order by the egress sorting unit 24.

To minimize the delay of data received by a second device, ideally reduced to 0, to save the required deskew buffer space, another embodiment is provided in the present disclosure. Referring to FIG. 4, in an embodiment, the processing unit 20 further includes a residual value compensation unit 26. The residual value compensation unit 26 is connected to the mapping construction unit 25 and the deskewing unit 10.

The residual value compensation unit 26 is configured to determine a minimum value among total delays of N channels as a first reference value. A total delay of a j-th channel is equal to a sum of a delay skew of an ingress lane included in the j-th channel and a delay skew of an egress lane included in the j-th channel.

A formula for calculating the first reference value is obtained as follows for reference: Min Delta T=min(Delta T0, Delta T1, . . . , Delta TN), where Min Delta T denotes the first reference value, Delta Tj denotes the total delay of the j-th channel, and 1≤j≤N.

The residual value compensation unit 26 is configured to determine a difference between the total delay of the j-th channel and the first reference value as a channel delay skew of the j-th channel.

A formula for calculating the channel delay skew of the j-th channel is obtained as follows for reference: Coef Tj-Delta Tj-Min Delta T, where Coef Tj denotes the channel delay skew of the j-th channel.

The residual value compensation unit 26 is configured to determine a maximum value among channel delay skews of the N channels as a second reference value.

A formula for calculating the second reference value is obtained as follows for reference: Max Coef T=max(Coef T0, Coef T0, . . . , Coef TN), where Max Coef T denotes the second reference value.

The residual value compensation unit 26 is configured to determine a difference between the second reference value and the channel delay skew of the j-th channel as a channel delay skew compensation for the j-th channel, and to transmit j-th channel information to the deskewing unit 10. The j-th channel information includes the channel delay skew compensation for the j-th channel and an ingress lane identifier of the j-th channel.

A formula for calculating the channel delay skew compensation for the j-th channel is obtained as follows for reference: channel delay skew compensation for the j-th channel=Max Coef T-Coef Tj.

It should be understood that the deskewing unit 10 may determine a port corresponding to the ingress lane included in the j-th channel based on the ingress lane identifier, and perform deskew processing on a data stream received through the port based on the channel delay skew compensation for the j-th channel. For example, in a case that the ingress lane identifier for the j-th channel indicates the i-th ingress lane, the deskewing unit 10 performs deskew processing on a data stream received via the i-th input terminal of the deskewing unit 10 based on the channel delay skew compensation for the j-th channel. In the example, i denotes a position sequence number of the ingress lane, and j denotes a delay skew sequence number of the ingress lane.

Referring to FIG. 3, in an embodiment, the input terminal of the i-th decoding descrambling unit 30 is connected to the i-th ingress lane through a first PCIe interface 60.

The output terminal of the i-th encoding-scrambling unit 40 is connected to the i-th egress lane through a second PCIe interface 70.

On the basis of the above technical solutions, a PCIe system is further provided in an embodiment of the present disclosure. The PCIe system includes a first device, a second device, and the above-described PCIe retimer.

An i-th output terminal of the first device is connected to the input terminal of the i-th decoding-descrambling unit 30 via the i-th ingress lane, and an i-th input terminal of the second device is connected to the output terminal of the i-th encoding-scrambling unit 40 via the i-th egress lane.

When the first device is configured as a root complex device, the second device is configured as an endpoint device. When the first device is configured as a configured as an endpoint device, the second device is configured as a root complex device.

When the PCIe retimer further includes the first lane mapping unit 50, the second device is arranged with a second lane mapping unit.

An i-th input terminal of the second lane mapping unit is connected to the i-th egress lane, and the i-th output terminal of the second lane mapping unit is connected to an input terminal of an i-th decoding-descrambling unit arranged in the second device.

Alternatively, the i-th egress lane is connected to the input terminal of the i-th decoding-descrambling unit arranged in the second device, an output terminal of the i-th decoding-descrambling unit arranged in the second device is connected to the i-th input terminal of the second lane mapping unit, and the i-th output terminal of the second lane mapping unit is connected to an i-th input terminal of a deskewing unit arranged in the second device.

The second lane mapping unit is configured to perform reverse switching on input terminals and output terminals of the second lane mapping unit based on a mapping relationship set. The reverse switching indicates that a switching relationship in the second lane mapping unit and a switching relationship in the first lane mapping unit 50 are reversed.

An example of the reverse switching is described as follows. It is assumed that both the first lane mapping unit 50 and the second lane mapping unit are provided with three input terminals and three output terminals. The connection relationship in the first lane mapping unit 50 is that a first input terminal is connected to a second output terminal, a second input terminal is connected to a third output terminal, and a third input terminal is connected to a first output terminal. The connection relationship in the second lane mapping unit is that a second input terminal is connected to a first output terminal, a third input terminal is connected to a second output terminal, and a first input terminal is connected to a third output terminal.

An electronic device is further provided according to an embodiment of the present disclosure. The electronic device includes the above-described PCIe system. The electronic device may be, but is not limited to, a mobile phone, a computer, a server, a smart wearable device, or the like.

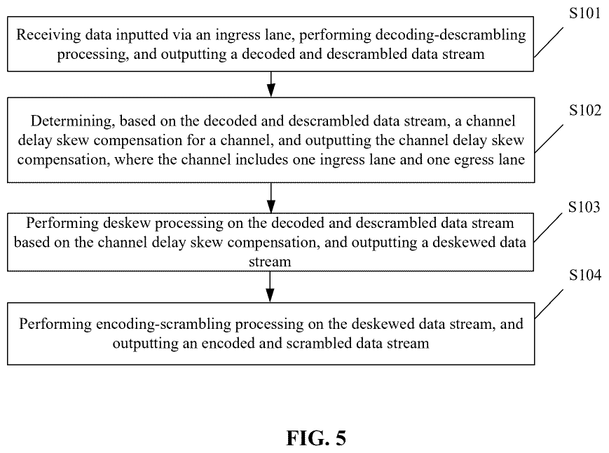

A method for signal processing, which is applied to a PCIe retimer, is further provided according to an embodiment of the present disclosure. Reference is made to FIG. 5, which is a schematic flowchart of a method for signal processing according to an embodiment of the present disclosure. The method includes the following steps.

S101: receiving data inputted via an ingress lane, performing decoding-descrambling processing, and outputting a decoded and descrambled data stream.

S102: determining, based on the decoded and descrambled data stream, a channel delay skew compensation for a channel, and outputting the channel delay skew compensation, where the channel includes one ingress lane and one egress lane.

S103: performing deskew processing on the decoded and descrambled data stream based on the channel delay skew compensation, and outputting a deskewed data stream.

S104: performing encoding-scrambling processing on the deskewed data stream, and outputting an encoded and scrambled data stream.

In an embodiment, the method further includes:
generating, based on the decoded and descrambled data stream, a mapping relationship set, where the mapping relationship set includes N mapping relationships, a j-th mapping relationship corresponds to a j-th channel, and the j-th mapping relationship is a mapping relationship between the j-th ingress lane and an (N+1−j)-th egress lane that are sorted based on delay skew, where 1≤j≤N; and
connecting, based on the mapping relationship set, an input terminal corresponding to the j-th ingress lane and an output terminal corresponding to the (N+1−j)-th egress lane, and outputting the deskewed data stream.

In an embodiment, the method further includes:
determining, based on the decoded and descrambled data stream, delay skew of each ingress lane of N ingress lanes; and
generating the mapping relationship set based on the delay skews of the N ingress lanes and delay skews of N egress lanes.

In an embodiment, the method further includes:
sorting the delay skew of each ingress lane of the N ingress lanes, and sorting the delay skew of each egress lane of the N egress lanes, where when each ingress lane of the N ingress lanes is sorted in an ascending order, each egress lane of the N egress lanes is sorted in a descending order, and when each ingress lane of the N ingress lanes is sorted in a descending order, each egress lane of the N egress lanes is sorted in an ascending order; and
constructing a j-th mapping relationship based on a j-th ingress lane and a j-th egress lane, and generating the mapping relationship set.

In an embodiment, the method further includes:
determining arrival time of target information in the decoded and descrambled data stream; and
determining, based on the arrival time, delay skew of each ingress lane of the N ingress lanes.

In an embodiment, the method further includes:
determining a minimum value among total delays of N channels as a first reference value, where a total delay of a j-th channel is a sum of a delay skew of an ingress lane included in the j-th channel and a delay skew of an egress lane included in the j-th channel;
determining a difference between the total delay of the j-th channel and the first reference value as a channel delay skew of the j-th channel;
determining a maximum value among channel delay skews of the N channels as a second reference value; and
determining a difference between the second reference value and the channel delay skew of the j-th channel as a channel delay skew compensation for the j-th channel, where the j-th channel information includes the channel delay skew compensation for the j-th channel and an ingress lane identifier of the j-th channel.

In an embodiment, the delay skew of the egress lane is obtained through in-band data stream transmission, out-band reading, or configuration after upper-layer software reading.

In summary, a PCIe retimer, a PCIe system, an electronic device, and a method for signal processing are provided according to the embodiments of the present disclosure. In the PCIe retimer, a decoding-descrambling unit receives data inputted via an ingress lane connected to the decoding-descrambling unit, performs decoding-descrambling processing, and outputs a decoded and descrambled data stream; a processing unit determines, based on the data stream outputted by each decoding-descrambling unit, a channel delay skew compensation for a channel, and transmits the channel delay skew compensation to a deskewing unit; the deskewing unit performs deskew processing on the decoded and descrambled data stream based on the channel delay skew compensation, and outputs the deskewed data stream; and an encoding-scrambling unit performs encoding-scrambling processing on the received deskewed data stream, and outputs an encoded and scrambled data stream to. A delay skew of an entire channel is considered during the deskew processing, which reduces an amount of a delay skew compensation, thereby significantly reducing data transmission delay and improving the data transmission efficiency.

The above are only preferred embodiments of the present disclosure, and are not intended to limit the present disclosure. For those skilled in the art, the present disclosure may have various modifications and changes. Any modifications, equivalent replacements, improvements, etc. made within the spirit and principles of the present disclosure fall within the protection scope of the present disclosure.

For those skilled in the art, it is apparent that the present disclosure is not limited to the details of the above exemplary embodiments and may be implemented in other forms without departing from the spirit or scope of the present disclosure. Accordingly, the embodiments as exemplary and non-restrictive in all respects. The protection scope of the present disclosure is defined by the appended claims rather than the foregoing descriptions, and it is therefore intended that all variations falling within the meaning and range of equivalents of the claims be embraced within the present disclosure. No reference numeral in the claims should be construed as limiting the protection scope of the claims.

1. A method for signal processing, applied to a peripheral component interconnect express (PCIe) retimer, comprising:
receiving data inputted via an ingress lane, performing decoding-descrambling processing, and outputting a decoded and descrambled data stream;
determining, based on the decoded and descrambled data stream, a channel delay skew compensation for a channel, and outputting the channel delay skew compensation, wherein the channel comprises one ingress lane and one egress lane;
performing deskew processing on the decoded and descrambled data stream based on the channel delay skew compensation, and outputting a deskewed data stream; and
performing encoding-scrambling processing on the deskewed data stream, and outputting an encoded and scrambled data stream.

2. The method according to claim 1, further comprising:
generating, based on the decoded and descrambled data stream, a mapping relationship set, wherein the mapping relationship set comprises N mapping relationships, a j-th mapping relationship corresponds to a j-th channel, and the j-th mapping relationship is a mapping relationship between the j-th ingress lane and an (N+1−j)-th egress lane that are sorted based on delay skew, wherein 1≤j≤N; and
connecting, based on the mapping relationship set, an input terminal corresponding to the j-th ingress lane and an output terminal corresponding to the (N+1−j)-th egress lane, and outputting the deskewed data stream.

3. The method according to claim 2, further comprising:
determining, based on the decoded and descrambled data stream, delay skew of each ingress lane of N ingress lanes; and
generating the mapping relationship set based on the delay skews of the N ingress lanes and delay skews of N egress lanes.

4. The method according to claim 3, further comprising:
sorting the delay skew of each ingress lane of the N ingress lanes, and sorting the delay skew of each egress lane of the N egress lanes, wherein when each ingress lane of the N ingress lanes is sorted in an ascending order, each egress lane of the N egress lanes is sorted in a descending order, and when each ingress lane of the N ingress lanes is sorted in a descending order, each egress lane of the N egress lanes is sorted in an ascending order; and
constructing a j-th mapping relationship based on a j-th ingress lane and a j-th egress lane, and generating the mapping relationship set.

5. The method according to claim 4, further comprising:
determining arrival time of target information in the decoded and descrambled data stream; and
determining, based on the arrival time, delay skew of each ingress lane of the N ingress lanes.

6. The method according to claim 4, further comprising:
determining a minimum value among total delays of N channels as a first reference value, wherein a total delay of a j-th channel is a sum of a delay skew of an ingress lane comprised in the j-th channel and a delay skew of an egress lane comprised in the j-th channel;
determining a difference between the total delay of the j-th channel and the first reference value as a channel delay skew of the j-th channel;
determining a maximum value among channel delay skews of the N channels as a second reference value; and
determining a difference between the second reference value and the channel delay skew of the j-th channel as a channel delay skew compensation for the j-th channel, wherein the j-th channel information comprises the channel delay skew compensation for the j-th channel and an ingress lane identifier of the j-th channel.

7. The method according to claim 3, wherein the delay skew of the egress lane is obtained through in-band data stream transmission, out-band reading, or configuration after upper-layer software reading.

8. A peripheral component interconnect express (PCIe) retimer, comprising a deskewing unit, a processing unit, N decoding-descrambling units and N encoding-scrambling units, wherein
an input terminal of an i-th decoding-descrambling unit of the N decoding-descrambling units is connected to an i-th ingress lane, an output terminal of the i-th decoding-descrambling unit is connected to an i-th input terminal of the processing unit and an i-th input terminal of the deskewing unit, an i-th output terminal of the deskewing unit is connected to an input terminal of an i-th encoding-scrambling unit of the N encoding-scrambling units, and an output terminal of the i-th encoding-scrambling unit is connected to an i-th egress lane, wherein 1≤i≤N, and the processing unit is connected to the deskewing unit;
a decoding-descrambling unit of the N decoding-descrambling units is configured to receive data inputted via an ingress lane connected to the decoding-descrambling unit, to perform decoding-descrambling processing, and to output a decoded and descrambled data stream;
the processing unit is configured to determine, based on the data stream outputted by each decoding-descrambling unit of the N decoding-descrambling units, a channel delay skew compensation for a channel, and to transmit the channel delay skew compensation to the deskewing unit, wherein the channel comprises one ingress lane and one egress lane;
the deskewing unit is configured to perform deskew processing on the decoded and descrambled data stream based on the channel delay skew compensation, and to output a deskewed data stream; and
an encoding-scrambling unit of the N encoding-scrambling unit is configured to perform encoding-scrambling processing on the received deskewed data stream, and to output an encoded and scrambled data stream.

9. The PCIe retimer according to claim 8, further comprising a first lane mapping unit, wherein
the i-th output terminal of the deskewing unit is connected to an i-th input terminal of the first lane mapping unit, an i-th output terminal of the first lane mapping unit is connected to the input terminal of the i-th encoding-scrambling unit, and the processing unit is connected to the first lane mapping unit;
the processing unit is configured to generate, based on the data stream outputted by each decoding-descrambling unit of the N decoding-descrambling units, a mapping relationship set, and to transmit the mapping relationship set to the first lane mapping unit, wherein the mapping relationship set comprises N mapping relationships, a j-th mapping relationship corresponds to a j-th channel, and the j-th mapping relationship is a mapping relationship between the j-th ingress lane and an (N+1−j)-th egress lane that are sorted based on delay skew, wherein 1≤j≤N; and
the first lane mapping unit is configured to perform, based on the mapping relationship set, switching on input terminals and output terminals of the first lane mapping unit, to connect the input terminal corresponding to the j-th ingress lane and the output terminal corresponding to the (N+1−j)-th egress lane, and is configured to forward a received deskewed data stream.

10. The PCIe retimer according to claim 9, wherein
the processing unit is configured to determine, based on the data stream outputted by each decoding-descrambling unit of the N decoding-descrambling units, delay skew of each ingress lane of N ingress lanes; and
the processing unit is configured to generate the mapping relationship set based on the delay skews of the N ingress lanes and delay skews of N egress lanes.

11. The PCIe retimer according to claim 10, wherein the processing unit comprises an ingress recording unit, an ingress sorting unit, an egress recording unit, an egress sorting unit, and a mapping construction unit, wherein
the ingress recording unit is connected to the ingress sorting unit, the egress recording unit is connected to the egress sorting unit, both the ingress sorting unit and the egress sorting unit are connected to the mapping unit, the output terminal of the i-th decoding-descrambling unit is connected to an i-th access terminal of the ingress recording unit, and the mapping construction unit is connected to the first lane mapping unit;
the ingress recording unit is configured to determine, based on the data stream outputted by each decoding-descrambling unit of the N decoding-descrambling units, the delay skew of each ingress lane of the N ingress lanes, and to transmit the delay skew of each ingress lane of the N ingress lanes to the ingress sorting unit;
the egress recording unit is configured to transmit the delay skew of each egress lane of the N egress lanes to the egress sorting unit;
the ingress sorting unit is configured to sort the delay skew of each ingress lane of the N ingress lanes;
the egress sorting unit is configured to sort the delay skew of each egress lane of the N egress lanes, wherein
when an ascending order is adopted by the ingress sorting unit, a descending order is adopted by the egress sorting unit, and when a descending order is adopted by the ingress sorting unit, an ascending order is adopted by the egress sorting unit; and
the mapping construction unit is configured to construct a j-th mapping relationship based on a j-th ingress lane sorted by the ingress sorting unit and a j-th egress lane sorted by the egress sorting unit, to generate the mapping relationship set, and to transmit the mapping relationship set to the first lane mapping unit.

12. The PCIe retimer according to claim 11, wherein
the ingress recording unit is configured to determine a target arrival time corresponding to the i-th decoding-descrambling unit, wherein the target arrival time is arrival time of target information in a data stream outputted by a decoding-descrambling unit; and
the ingress recording unit is configured to determine, based on target arrival time corresponding to each decoding-descrambling unit of the N decoding-descrambling units, delay skew of each ingress lane of the N ingress lanes.

13. The PCIe retimer according to claim 11, wherein the processing unit further comprises a residual value compensation unit, wherein
the residual value compensation unit is connected to the mapping construction unit and the deskewing unit respectively;
the residual value compensation unit is configured to determine a minimum value among total delays of N channels as a first reference value, wherein a total delay of a j-th channel is a sum of a delay skew of an ingress lane comprised in the j-th channel and a delay skew of an egress lane comprised in the j-th channel;
the residual value compensation unit is configured to determine a difference between the total delay of the j-th channel and the first reference value as a channel delay skew of the j-th channel;
the residual value compensation unit is configured to determine a maximum value among channel delay skews of the N channels as a second reference value; and
the residual value compensation unit is configured to determine a difference between the second reference value and the channel delay skew of the j-th channel as a channel delay skew compensation for the j-th channel, and to transmit j-th channel information to the deskewing unit, wherein the j-th channel information comprises the channel delay skew compensation for the j-th channel and an ingress lane identifier of the j-th channel.

14. The PCIe retimer according to claim 8, wherein the input terminal of the i-th decoding-descrambling unit is connected to the i-th ingress lane through a first PCIe interface; and
the output terminal of the i-th encoding-scrambling unit is connected to the i-th egress lane through a second PCIe interface.

15. The PCIe retimer according to claim 10, wherein the delay skew of the egress lane is obtained through in-band data stream transmission, out-band reading, or configuration after upper-layer software reading.

16. A peripheral component interconnect express (PCIe) system, comprising a first device, a second device, and the PCIe retimer according to claim 8, wherein
an i-th output terminal of the first device is connected to the input terminal of the i-th decoding-descrambling unit via the i-th ingress lane, and an i-th input terminal of the second device is connected to the output terminal of the i-th encoding-scrambling unit via the i-th egress lane; and
when the first device is configured as a root complex device, the second device is configured as an endpoint device; and when the first device is configured as an endpoint device, the second device is configured as a root complex device.

17. The PCIe system according to claim 16, wherein the second device comprises a second lane mapping unit when the PCIe retimer comprises the first lane mapping unit, wherein
an i-th input terminal of the second lane mapping unit is connected to the i-th egress lane; and
the second lane mapping unit is configured to perform, based on the mapping relationship set, reverse switching on input terminals and output terminals of the second lane mapping unit, wherein the reverse switching indicates that a switching relationship in the second lane mapping unit and a switching relationship in the first lane mapping unit are reversed.

18. An electronic device, comprising the peripheral component interconnect express (PCIe) system according to claim 16.
